(19) United States
(12) Patent Application Publication
(10) Pub. No.: US 2026/0050646 A1
(43) Pub. Date: Feb. 19, 2026

(54) COMPILER FOR SUPPORTING GENERAL SYMBOLIC-NUMERIC NONLINEAR SOLVING IN IMPLICIT DIFFERENTIAL EQUATION SOLVERS VIA CANONICAL FORMS IN COMPRESSED REPRESENTATION

(71) Applicant: JuliaHub, Inc., Boston, MA (US)

(72) Inventors: Christopher Rackauckas, Cambridge, MA (US); Yingbo Ma, Newton, MA (US); Oscar Smith, Cambridge, MA (US)

(21) Appl. No.: 19/301,379

(22) Filed: Aug. 15, 2025

Related U.S. Application Data
(60) Provisional application No. 63/684,106, filed on Aug. 16, 2024.

(51) Int. Cl. G06F 17/13

(52) U.S. Cl. CPC G06F 17/13

(57) ABSTRACT

A system for solving nonlinear problems in implicit differential equations comprises hardware processors that transform differential equation systems into a unified canonical form enabling efficient numerical solving across multiple integration methods. The processors represent differential equations in a reduced canonical form G(x; v₁, v₂, γ, c)=v₁+Mx−γ(h) f(x+v₂, tₙ+ch) incorporating solution vectors, integrator parameters, mass matrices, and time parameters. The system generates model-specific mapping functions N(x)=y and N⁻¹(y, γ, v₁, v₂)=x that transform between differential algebraic equation states and compressed nonlinear solver states, eliminating algebraically redundant variables through symbolic analysis. This compressed representation reduces computational complexity from O(n³) to O(m³) where m<n, while integrator-specific functions v₁, v₂, and γ(ρh) encode method-specific discretization parameters.

### CROSS-REFERENCE TO RELATED APPLICATIONS

This application claims priority to U.S. Provisional Patent Application No. 63/684,106 filed Aug. 16, 2024 entitled “COMPILER FOR SUPPORTING GENERAL SYMBOLIC-NUMERIC NONLINEAR SOLVING IN IMPLICIT DIFFERENTIAL EQUATION SOLVERS VIA CANONICAL FORMS IN COMPRESSED REPRESENTATION”, the entire content of which is incorporated by reference herein.

### TECHNICAL FIELD

The present application relates to computational methods and systems for solving differential equation systems. More particularly, the application relates to compiler infrastructures that transform differential equations into optimized representations for numerical solving.

### BACKGROUND

Many scientific simulations represent physical phenomena through ordinary differential equations (ODEs) and differential-algebraic equations (DAEs). These mathematical representations require computational methods for generating approximate solutions.

Computational solvers employ various approaches including symbolic analysis, numerical analysis, and hybrid symbolic-numeric methods. Symbolic analysis represents values exactly and derives solutions through mathematical manipulation. Numerical methods find approximations when exact solutions cannot be determined analytically.

Inline integration is a hybrid approach that combines symbolic and numeric techniques by inserting discretization expressions from numerical integration algorithms directly into the differential equation model. The augmented system undergoes both numerical analysis and symbolic manipulation to produce a computationally efficient form.

Current inline integration implementations face technical constraints because each discretization method requires a separate implementation. For instance, implicit linear multistep methods like Adams-Moulton and backward differentiation formula (BDF) methods need different implementations than implicit Runge-Kutta methods including diagonally implicit (DIRK) and singly diagonally implicit (SDIRK) variants.

These implementation requirements create computational challenges in systems designed for scientific simulation. Separate code bases increase memory requirements and computational overhead. Each integration method maintains distinct interfaces and optimization routines. Large-scale applications processing millions of equations experience compounded inefficiencies.

Existing methods also face algorithmic constraints. Current inline integration supports only non-adaptive fixed time step and fixed order integration. Modern scientific applications often require dynamic parameter adjustment based on solution behavior for both accuracy and efficiency.

Computational complexity presents additional technical challenges. Newton-Raphson methods for implicit rootfinding exhibit O(n³) computational scaling where n represents the equation count. This cubic scaling creates processing constraints for large-scale simulations.

Accordingly, a need exists for computational methods that address these constraints while maintaining solution accuracy and enabling broader integration method compatibility.

### SUMMARY

Disclosed herein are methods and systems for solving nonlinear problems in implicit differential equations. One implementation comprises hardware processors configured to represent differential equations in a reduced canonical form using mathematical expressions incorporating solution vectors, integrator parameters, mass matrices, step functions, and time parameters.

The processors generate model-specific functions including a first mapping function that determines nonlinear solver states from differential algebraic equation states, and a second mapping function providing the inverse transformation. The system uses integrator-specific functions of previous integrator states.

Solutions are determined by computing nonlinear solver states and step values through the reduced canonical form. The system processes differential equations through state representation transformations using the mapping functions and integrator parameters.

Some implementations generate additional model-specific functions including work functions, error functions, and step controller functions that customize the solving process for particular mathematical models. Other implementations generate the canonical form using strongly connected components comprising lists of nonlinear solves. These components may include directed acyclic graphs enabling parallelization between independent solves.

Various implementations configure integrator parameters as step size functions or constants. Some encode integrator-specific functions as zero values for particular methods.

The system may be specialized for ordinary differential equations without mass matrices or for fully implicit differential algebraic equations using specific input correspondences.

Some implementations include compressed dense output state decompression on demand. Solution determination may use decompressed states or Hermite interpolation modifications.

Different implementations employ various numerical methods including implicit Runge-Kutta methods (DIRK, SDIRK, Gauss-Radau), explicit SDIRK methods, implicit linear multistep methods (Adams-Moulton, BDF), or semi-implicit Rosenbrock methods.

Certain implementations use fully implicit Runge-Kutta methods with fixed or adaptive order, generating multiple canonical forms specialized to different allowed orders.

Also disclosed are computational methods that combine symbolic and numeric techniques, transform equations into canonical forms, and employ compressed representations for enhanced computational efficiency in scientific and engineering applications.

### BRIEF DESCRIPTION OF THE DRAWINGS

FIG. 1A depicts a flow diagram for supporting general symbolic-numeric nonlinear solving in implicit differential equation solvers via canonical forms in compressed representation according to one embodiment.

FIG. 1B depicts a flow diagram continuation for supporting general symbolic-numeric nonlinear solving in implicit differential equation solvers via canonical forms in compressed representation according to one embodiment.

FIG. 2 depicts a block diagram illustrating one embodiment of a computing device that implements the disclosed methods and systems.

FIG. 3 depicts a block diagram illustrating an exemplary relationship between a compiler and a general solver according to one embodiment.

FIG. 4A depicts exemplary steps for solving differential algebraic equation systems using a conventional inline integration approach.

FIG. 4B depicts exemplary steps for solving differential algebraic equation systems by transforming the equations into canonical forms and using a compressed representation according to one embodiment.

### DETAILED DESCRIPTION

The following detailed description presents various implementations of systems and methods for solving differential equation problems through canonical form transformations and compressed representations. Reference will be made to the accompanying drawings, where like reference numerals designate corresponding or similar elements throughout the various figures.

As mentioned, scientific and engineering simulations rely heavily on solving complex mathematical equations that describe physical phenomena, from aerodynamic flows and chemical reactions to weather patterns and mechanical systems. Current computational approaches for solving these differential equation systems face technical challenges that limit their practical application and scalability.

A limitation of existing methods relates to their fragmented approach to equation solving. Each different type of numerical integration method requires its own specialized solver implementation, creating a proliferation of redundant code bases and computational frameworks. This fragmentation results in duplication of effort, increased memory requirements, and maintenance overhead. Additionally, conventional approaches scale poorly with problem size, exhibiting cubic computational complexity that becomes prohibitive for large-scale simulations commonly encountered in real-world applications.

The present subject matter addresses these limitations by introducing a unified computational framework that transforms how computer systems process differential equation problems. Rather than maintaining separate implementations for each integration method, the system establishes a standardized mathematical representation, termed a canonical form, into which all major implicit differential equation solvers can be expressed. This approach creates a universal interface that enables a single optimized implementation to support diverse numerical methods including backward differentiation formulas, implicit Runge-Kutta methods, and semi-implicit schemes.

One aspect of the implementations described herein is a compressed representation technique that reduces computational complexity by identifying and eliminating algebraically redundant variables through symbolic analysis. This compression transforms the original n-variable system into a reduced m-variable representation where m is substantially less than n, thereby reducing memory requirements and computational overhead while preserving mathematical accuracy. The compressed representation enables parallel processing capabilities through strongly connected component decomposition, allowing independent equation clusters to be solved simultaneously across multiple processor cores.

The practical benefits of this approach may be both substantial and measurable. For example, in some typical applications, memory allocation requirements may be reduced by approximately 70 percent, while the unified codebase may eliminate 80 to 90 percent of the redundant solver-specific implementations required by conventional approaches. Computational performance improvements of 30 to 60 percent may likewise be achievable for problems with varying stiffness characteristics, and the system supports adaptive time-stepping and order selection capabilities that were previously unavailable in inline integration methods.

Thus, the present implementations represent a shift in computational differential equation solving by transforming fragmented, method-specific implementations into a cohesive, adaptive framework. The resulting system enables more efficient utilization of computational resources, supports larger and more complex simulations, and provides a foundation for advanced scientific computing applications that require both performance and flexibility. The unified approach reduces development complexity while expanding computational capabilities, making simulation techniques more accessible across diverse scientific and engineering domains.

The present implementations specifically address computational efficiency challenges in computer systems processing large-scale differential equation systems. By implementing a compressed representation approach, the system achieves measurable reductions in memory allocation requirements and processing cycles compared to conventional solver implementations. The technical improvements include elimination of redundant solver-specific code bases, enabling parallel processing through directed acyclic graph structures, and providing adaptive time-stepping capabilities previously unavailable in inline integration systems.

In one embodiment, the memory management architecture for implementing the compressed representation may include allocation strategies that optimize cache performance and minimize memory fragmentation. The system may allocate separate memory pools for different computational phases, including dedicated regions for the compressed state vectors, intermediate calculation buffers, and temporary storage for symbolic transformations. Each memory pool uses alignment strategies that correspond to processor cache line boundaries, typically 64-byte alignment on modern x86 architectures, ensuring that frequently accessed data structures do not span multiple cache lines unnecessarily. The allocation system also implements memory prefetching hints that inform the processor's cache management subsystem about anticipated access patterns during the iterative solving process.

As used herein, a compressed representation refers to a mathematical transformation of a differential equation system that reduces the computational state space from n variables to m variables (where m<n) by eliminating algebraically dependent variables through symbolic analysis, thereby reducing memory allocation requirements and computational complexity while preserving solution accuracy.

As used herein, a canonical form refers to a standardized mathematical representation of implicit differential equation solvers that may be expressed as: G(x; v₁, v₂, γ, c)=v₁+M x−γ(h) f (x+v₂, tₙ+ch) where x represents solution variables, M represents mass matrices, f represents the differential equation function, and v₁, v₂, γ, c are integrator-specific parameters.

As used herein, a reduced canonical form refers to a canonical form that has undergone symbolic optimization to eliminate redundant variables and computational dependencies, resulting in a compressed state representation that operates on a subset of the original system variables while maintaining mathematical equivalence to the full system solution.

As used herein, model-specific functions refer to compiler-generated mathematical functions customized for a particular differential equation system, comprising: (a) mapping function N(x) that transforms from DAE state to nonlinear solver state, (b) inverse mapping function N⁻¹(y, γ, v₁, v₂) that transforms from nonlinear solver state back to DAE state, and (c) canonical form function G(x; v₁, v₂, γ, c) that represents the reduced nonlinear system to be solved. Model-specific functions may additionally include: (d) work estimation function W(k) for computational cost assessment, (e) error estimation function E(k) for adaptive time-stepping, and (f) step controller function newh(k) for step size determination, all generated through symbolic analysis of the specific differential equation model.

As used herein, integrator-specific functions refer to mathematical functions v₁, v₂, and γ(ρh) that encode the numerical integration method's discretization parameters and depend on the previous integrator state, where v₁ and v₂ represent method-dependent offset vectors and γ represents a scaling function of the step size h.

As used herein, strongly connected components refer to maximal sets of variables and equations in the nonlinear system that are mutually dependent, identified through graph analysis of the equation-variable dependency structure, enabling decomposition of the nonlinear solve into smaller independent or sequentially dependent subsystems.

As used herein, DAE state (x) refers to the complete vector of differential and algebraic variables in the original differential equation system, whereas nonlinear solver state (y) may refer to the reduced vector containing the variables required for the nonlinear solve, obtained through symbolic elimination of algebraically dependent variables.

As mentioned, there are many methods to approximate differential equations, including explicit methods, like explicit Runge-Kutta, to implicit and semi-implicit methods like implicit Runge-Kutta or backwards differentiation formulae (BDF) methods.

For the implicit methods, an implicit rootfinding equation, expressed as “find x such that G(x)=0”, is approximated by many steps of the solution process. Implicit methods are used because they have good stability properties (allowing for large time steps on ill-conditioned stiff problems) and due to matching the implicit form of DAEs.

Solving implicit rootfinding problems, however, is generally computationally expensive. When using common methods such as the Newton-Raphson method and its derivatives (which includes Quasi-Newton methods, Pseudotransient, homotopy methods, Levenburg-Marquedt), the implicit equation is solved by using successive linear approximations. This involves solving a linear system via factorizations such as lower-upper (LU) or QR, or using Krylov-based techniques like conjugate gradient or GMRES. Alternative methods for solving such implicit systems may use other iterative methods, like functional iteration, Anderson acceleration, or multistep methods.

In either case, the computational cost of the system can grow rapidly as the size or complexity of the system increases. More ill-conditioned systems can take more iterations in order to converge, and the cost of the internal steps in the iterations can grow as well. For example, the computational complexity of the LU factorization commonly used in a Newton method is O(n³) where n is the number of equations in the nonlinear system, showing a cubic cost growth with system increases. While purely numerical techniques such as exploiting sparsity in the Jacobian can be used in order to mitigate this issue, larger implicit systems can be more expensive to handle.

The data structure organization for the compressed canonical form may use specialized container implementations that support both dense and sparse computational patterns. The system may employ hybrid data structures that maintain dense representations for frequently accessed variables while utilizing compressed sparse formats for coefficient matrices and dependency relationships. For the mapping functions N and N 1, the implementation uses lookup tables with hash-based indexing for rapid state transformations, combined with precomputed offset arrays that enable vectorized memory access patterns during bulk state conversions. These data structures are designed to minimize pointer chasing and maximize spatial locality for the specific access patterns generated by the canonical form computations.

In contrast to purely numerical methods, symbolic mathematical techniques can be used to decrease the computational cost of handling the implicit system by symbolically optimizing the nonlinear system to be solved before applying the numerical method. At a high level, if certain relationships can be found in the nonlinear system which must be enforced, those can be taken into account and handled before the numerical steps.

For example, to solve the system of equations G(x)=[cos(xy); x−y]=0, i.e. find (x,y) which simultaneously make cos(xy)=0 and x−y=0. While solving for two variables can be hard, x−y=0 implies that x=y. Substitution can then get cos(x²)=0 as an isolated equation. This can then be used to independently solve for x, and thereby obtain y. In other words, while solving for two variables at the same time can be difficult, symbolic techniques can turn one difficult equation into two equations that are easier to solve. In this example, the optimization would first solve for x independently and then derive y from x. The above optimization is just one example of a symbolic-numeric algorithm. There are many symbolic-numeric algorithms that allow for applying such optimizations before applying a generic Newton solve on the generated equations (e.g., symbolic simplification, tearing).

One difficulty with implementing these symbolic-numeric techniques in practice is how to apply these techniques within full simulation software stacks where implicit rootfinding is just one step of a larger solver process. For example, implicit integration methods for ODEs and DAEs implicitly solve such nonlinear systems internally, but do not expose the underlying equations to the user of the software. As a result, the user cannot help the implementation specialize the solving.

To address this issue, inline integration was developed to target automated symbolic specialization on specific differential equation solvers. Using inline integration, an implicit integration algorithm can be merged with the model by substituting the derivatives with their approximation formulae, and then solving the system using all available numerical and symbolic techniques. In this way the differential equations are eliminated and the resulting model becomes a set of difference equations (AEs).

For example, for an ODE of the form u′=f(u,t) solved over the time interval (t₀, t₁) with initial condition u₀=u(t₀), time stepping with the implicit Euler method uses the formulae:

$${u}_{n + 1} = {u}_{n} + hf ( {u}_{n + 1} , {t}_{n + 1} )$$

where h is the step size, uₙ is the approximation to the solution at u(t₀+nt). To solve for the update value uₙ₊₁, the following rootfinding function can be created:

$$G ( {u}_{n + 1} ) = {u}_{n + 1} - {u}_{n} - hf ( {u}_{n + 1} , {t}_{n + 1} )$$

Note that this can be naturally extended to ODEs with mass matrices (Mu′=f(u,t)) and DAEs (f (t,u,u′)), but for simplicity of explanation the extra variables are omitted here.

In this context, inline integration performs symbolic optimizations on this form of the function to generate an optimized nonlinear solve specific to the Implicit Euler method. In the original paper, it is noted that higher order BDF methods such as the second order BDF formula:

$${U}_{n + 1} = 6 / 11 hf ( {u}_{n + 1} , {t}_{n + 1} ) + ( ( 18 / 11 ) * {u}_{n} - ( 9 / 11 ) {u}_{n - 1} + 2 / 11 {u}_{n - 2} )$$

follows a common form with implicit Euler, namely, uₙ₊₁=hf(uₙ₊₁,tₙ₊₁)+û, where here û=(18/11)*uₙ−(9/11)uₙ₋₁+2/11 uₙ₋₂. Using this form, all BDF methods can be supported through inline integration.

As an example, the authors discuss a case of the form:

$$\begin{matrix}{{u}_{1}}^{′} = {u}_{2} \\ {{u}_{2}}^{′} = f ( {u}_{1} , {u}_{2} , t )\end{matrix}$$

For this specific ODE, the common form of the BDF methods would give an implicit equation of the form:

$$\begin{matrix}{u}_{1} = {hu}_{2} + {\hat{u}}_{1} \\ {u}_{2} = hf ( {hu}_{2} + {\hat{u}}_{1} , {u}_{2} , t ) + {\hat{u}}_{2}\end{matrix}$$

In total, the Newton method would require solving for u₂ using the second equation (since the second equation is independent of u₁), and the first equation can be deduced explicitly using the solution for u₂. If u₁ is a vector of size n and u₂ is a vector of size m, the computational cost changes from a Newton method of a size n+m system to a Newton method on a size m system.

### Limitations of Inline Integration

As mentioned, current implementations of inline integration are bespoke to inline integration and thus are separated from general solvers. Additionally, current solvers which support inline integration only support non-adaptive fixed time step and fixed order integration.

### Extending Inline Integration to General Symbolic-Numeric Nonlinear Solving in Implicit Differential Equation Solvers Via Canonical Forms in Compressed Representation

In contrast to the original formulation of inline integration which requires separate solver implementations to support inline integration, the implementations described herein include a general compiler and solver infrastructure that supports symbolic-numeric optimizations of nonlinear solvers in implicit differential equation solvers without requiring the inlining of the integration process. This allows for compiler targets from a symbolic-numeric engine to target many different general solvers. In other words, the general compiler and solver infrastructure described herein allows for symbolic-numeric optimizations of internal nonlinear solves without being tied to a single solver.

The methods and systems for general symbolic-numeric nonlinear solving in implicit differential equation solvers via canonical forms in compressed representation described herein includes designing the general solver software to have hooks such that, when the function hooks are appropriately applied, the resulting integration process is similar to that of inline integration in terms of performance. Targeting a model for inline integration therefore includes optimizing functions for the solver hooks and then calling the general solver with the optimized functions.

The compiler optimization process may involve multiple passes of symbolic analysis that progressively refine the canonical form representation. In one embodiment, the first pass performs dependency analysis to construct the bipartite graph of equations and variables, utilizing graph algorithms such as Tarjan's strongly connected components algorithm to identify computational clusters. The second pass applies symbolic simplification techniques including algebraic manipulation, common subexpression elimination, and dead code removal to reduce the computational complexity of the generated functions. The third pass performs platform-specific optimizations that adapt the generated code to target hardware characteristics, including instruction scheduling for specific processor pipelines, register allocation strategies, and vectorization directives for SIMD instruction sets.

The code generation phase produces optimized implementations that exploit specific features of the target computing environment. For CPU-based implementations, the compiler generates loop unrolling patterns and prefetch instructions that align with the processor's out-of-order execution capabilities. For GPU implementations, the compiler restructures the computational kernels to maximize occupancy and minimize divergent branching within thread warps. The generated code includes runtime adaptation mechanisms that monitor computational performance and dynamically adjust algorithmic parameters such as iteration tolerances and convergence criteria based on observed hardware behavior and solution characteristics.

To achieve this goal, many (semi-) implicit numerical solvers can be formulated into a common nonlinear solver form. This nonlinear solver form is written as:

$$G ( x , {v}_{1} , {v}_{2} , γ , c ) = {v}_{1} + Mx - γ ( h ) f ( x + {v}_{2} , {t}_{n} + ch )$$

For Mu′=f(u,p,t), ODEs are supported by making M=I. And note when using the general DAE form f(t,u,u′), M=∂f/∂u′. Note that in this form, Implicit Euler is achieved by making v₁=−uₙ, c=1, v₂=0, and γ(h)=h, while the 2nd order BDF method is achieved by making v₁=((18/11)*uₙ−(9/11)uₙ₋₁+2/11 uₙ₋₂), v₂=0, c=1, and γ(h)=6/11 h.

However, while the trivial case was previously identified, it can be noted that multi-step methods can be decomposed into this general form by not requiring that ‘uₙ₊₁=x’, the update step. To demonstrate this, many other methods, such as (E)SDIRK and implicit Runge-Kutta methods, can be achieved via this canonical form. This canonical form may require multiple calls to the optimized nonlinear solve, but a single optimized compiled function can account for all stages of the stepper.

For example, the KenCarp4 (E)SDIRK method can be decomposed into successive solves of the canonical form. This method can be decomposed into successive solves of the canonical form.

$$set {x}_{1} = {u}_{n} , γ ( h ) = \text{.44} h , c = 0.87 , {v}_{1} = 0.44 f ( {u}_{n} , {t}_{n} ) , {v}_{2} = 0 \qquad a .$$

b. compute x₂ as the root of G

$$set c = 0.6 , {v}_{1} to 0.26 f ( {x}_{1} , t ) - 0.09 f ( {x}_{2} , t + 0.87 ) \qquad c .$$

d. compute x₃ as the root of G

$$set c = 1 , {v}_{1} to 0.19 f ( {x}_{1} , t ) - 0.6 f ( {x}_{2} , t + 0.87 ) + 0.97 f ( {x}_{2} , t + 0.6 ) \qquad e .$$

f. compute x₄ as the root of G
g. uₙ₊₁ is equal to x₄

Next, the implicit-explicit form of the KenCarp4 method can be decomposed into successive solves of the canonical form, where the implicit equation is labeled fᵢ and the explicit equation is labeled fₑ.

$$\begin{matrix}a . & \\ set {x}_{1} = {u}_{n} , γ ( h ) = \text{.44} h , c = 0.87 , {v}_{1} = 0 \text{.44} fi ( {u}_{n} , {t}_{n} ) + 0.87 {f}_{e} ( {u}_{n} , {t}_{n} ) , \\ {v}_{2} = 0 & \end{matrix}$$

b. compute x₂ as the root of G

$$\begin{matrix}c . & \\ set c = 0.6 , \\ {v}_{1} to 0.26 fi ( {x}_{1} , t ) - 0.09 fi ( {x}_{2} , t + 0.87 ) + 0.53 {f}_{e} ( {x}_{1} , t ) + 0.07 {f}_{e} ( {x}_{2} t + 0.87 ) & \end{matrix}$$

d. compute x₃ as the root of G

$$\begin{matrix}e . & \\ set c = 1 , \\ {v}_{1} to 0.19 fi ( {x}_{1} , t ) - 0.6 fi ( {x}_{2} , t + 0.87 ) + 0.97 fi ( {x}_{2} , t + 0.6 ) + 0.4 {f}_{e} ( {x}_{1} , t ) - 0.44 {f}_{e} ( {x}_{2} , t + 0.87 ) + 1.04 {f}_{e} ( {x}_{2} , t + 0.6 ) & \end{matrix}$$

f. compute x₄ as the root of G
g. uₙ₊₁ is equal to x₄

Using this understanding of the integration methods to the canonical form, a single integration implementation (complete with features such as time step and order adaptivity) can be developed such that inline integration results can be used with many implicit solvers.

Alternatively, a simplified form can be used

$${G}^{′} ( {{v}_{2}}^{′} ; {{t}_{n}}^{′} , {{v}_{1}}^{′} ) = {v}_{1} - f ( {{v}_{2}}^{′} , {{t}_{n}}^{′} )$$

In this form, v₁′=(v₁+M x)/γ(h), v₂′=x+v₂ and tₙ′=tₙ+ch. This form is likely slightly beneficial because it reduces the amount of variables that the symbolic compiler has to deal with which may lead to shorter compile times, or possibly better performance since less data is being manipulated by the nonlinear solve.

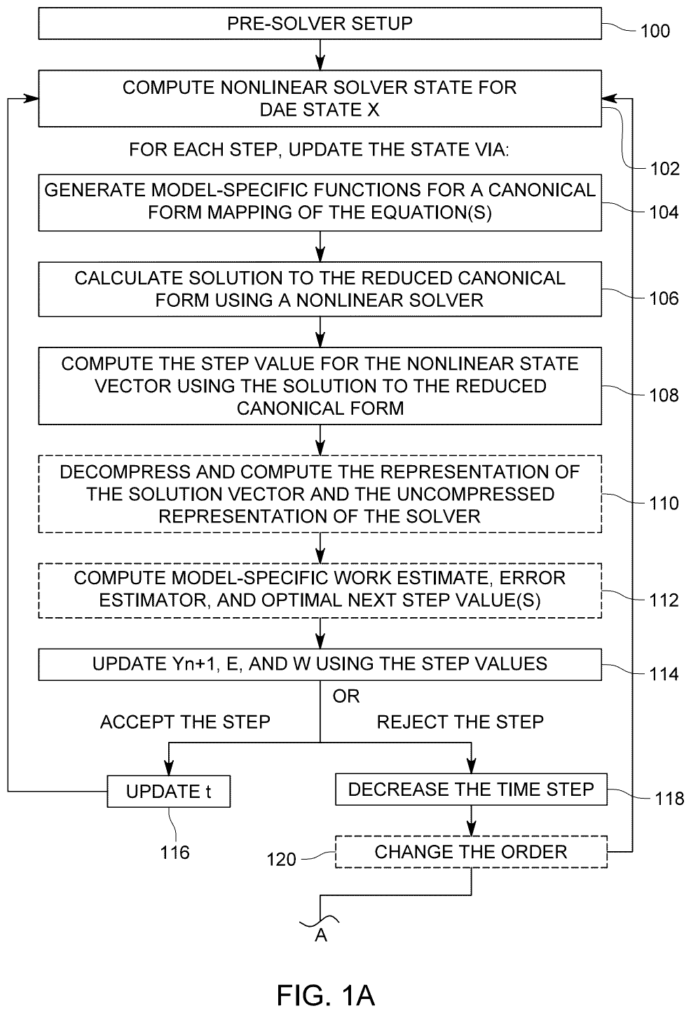

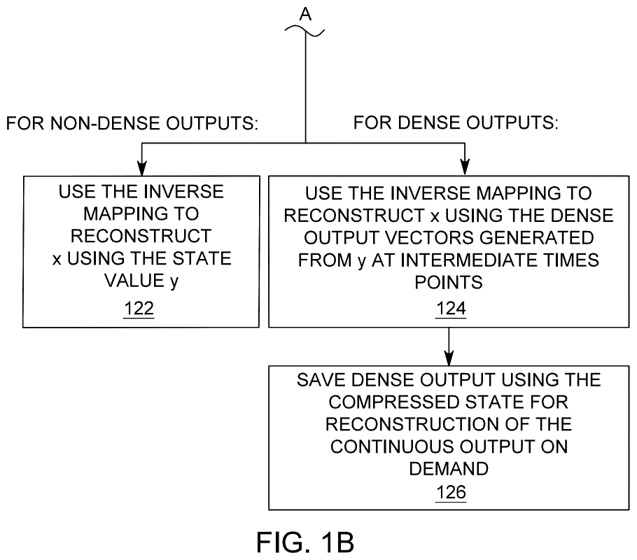

To illustrate general symbolic-numeric nonlinear solving in implicit differential equation solvers via canonical forms in compressed representation described herein and shown in FIGS. 1A and 1B, the solver loop may assume:

Mapping N(x)=y which computes the nonlinear solver state y from the DAE state x.

Mapping N⁻¹(y, γ, v₁, v₂)=x which computes the DAE state x from a nonlinear solver state y.

Integrator-specific functions v₁ and v₂ and γ(ρh) of the previous integrator state.

Optional model-specific work, error, and step controller functions, W(k), E(k), and newh(k) respectively.

The generalized solver form can then be specified as follows (note: γ refers to γ(h) when not specified) and illustrated in FIGS. 1A and 1B. Referring to FIG. 1A:

At step 100, pre-solver setup may be performed. This may include computing the proposed time step, the proposed order, etc. according to standard techniques.

Step 100 represents an initialization phase that establishes the computational parameters necessary for the subsequent nonlinear solving process within the canonical form framework. This pre-solver setup phase encompasses several determinations that influence the efficiency and accuracy of the overall differential equation solving process.

The primary function of step 100 involves computing the proposed time step size, which serves as a parameter in the canonical form G(X; v₁, v₂, γ, c)=v₁+M x−γ(h) f(x+v₂, tₙ+ch). The time step h appears explicitly in the γ(h) scaling function and implicitly affects the computation of the integrator-specific functions v₁ and v₂. Unlike conventional inline integration implementations that are constrained to non-adaptive fixed time step approaches, the canonical form framework described herein supports adaptive time-stepping capabilities that dynamically adjust computational parameters based on solution behavior.

Proposed order determination is another component of the pre-solver setup that may be relevant for adaptive order integration methods. The system supports multiple integration approaches including implicit Runge-Kutta methods such as diagonally implicit Runge-Kutta (DIRK), singly diagonally implicit Runge-Kutta (SDIRK), and Gauss-Radau methods, as well as implicit linear multistep methods including Adams-Moulton and backward differentiation formula (BDF) methods. For fully implicit Runge-Kutta methods with adaptive order capabilities, the system generates multiple specialized canonical form functions G corresponding to different allowed orders, enabling dynamic selection during the stepping process.

The technical limitations identified in conventional approaches may be addressed by computational efficiency considerations during this setup phase. Traditional Newton-Raphson methods for implicit rootfinding exhibit O(n³) computational complexity scaling, where n represents the total number of equations in the nonlinear system. The pre-solver setup phase incorporates work estimation calculations that account for the compressed representation approach, which reduces computational complexity from O(n³) to O(m³) where m represents the size of the reduced system and m<n.

Step 100 also encompasses the initialization of integrator-specific parameters that may be used throughout the solving process. These parameters include the determination of whether γ functions as a linear function of step size h or operates as a constant, and the specification of whether integrator-specific functions v₁ or v₂ should be encoded as zero values for particular integration methods. For example, the implicit Euler method uses v₁=−uₙ, c=1, v₂=0, and γ(h)=h, while the second-order BDF method employs v₁=((18/11)*uₙ−(9/11)uₙ₋₁+2/11 uₙ₋₂), v₂=0, c=1, and γ(h)=6/11 h.

The setup phase may, in some embodiments, incorporate memory management considerations specific to the compressed representation architecture. This includes allocation strategies that optimize cache performance and minimize memory fragmentation through separate memory pools for different computational phases, including dedicated regions for compressed state vectors, intermediate calculation buffers, and temporary storage for symbolic transformations. The system may implement 64-byte alignment strategies corresponding to processor cache line boundaries on modern x₈₆ architectures, ensuring that frequently accessed data structures do not span multiple cache lines unnecessarily.

For systems involving strongly connected component decomposition, the pre-solver setup may also establish a parallel execution framework that enables independent equation clusters to be solved simultaneously across multiple processor cores. This initialization may include configuring task-based parallelism structures and establishing memory buffer coordination mechanisms that facilitate information flow between parallel strongly connected component solves while avoiding false sharing through appropriate memory region separation.

At step 102, also referred to as the solver step, the nonlinear solver state is computed from the mapping y=N(x) and for each step s, the state y is updated. Updating the state y may include sub-steps 104, 106, 108 and, optionally, 110.

Step 102 is the computational phase where the nonlinear solver state is computed and iteratively updated through the canonical form framework. This solver step encompasses the primary mathematical operations that transform the differential algebraic equation system into its compressed representation and subsequently determine the solution through specialized nonlinear solving techniques.

The initial operation in step 102 includes computing the nonlinear solver state y from the differential algebraic equation state x through the mapping function N(x)=y. This mapping function serves as an interface between the original system representation and the compressed computational state. The mapping N transforms the complete vector of differential and algebraic variables in the original differential equation system into a reduced vector containing the variables required for the nonlinear solve. This transformation is achieved through symbolic elimination of algebraically dependent variables, as demonstrated in the example discussed herein where the mapping N([u₁, u₂])=u₂ reduces a two-variable system to a single-variable nonlinear solve.

The iterative updating of state y occurs through a sequence of sub-steps that apply the canonical form mathematics to determine the solution. For each integration step s, the state y undergoes modification through the coordinated execution of sub-steps 104, 106, 108 and optionally sub-step 110. This structured approach ensures that the compressed representation maintains mathematical equivalence to the full system solution while operating on a substantially reduced computational domain.

At sub-step 104, the γ and v₁ are computed for the canonical form mapping of the equation. Sub-step 104 involves the computation of the integrator-specific parameters γ and v₁ for the canonical form mapping. These parameters encode the numerical integration method's discretization characteristics and depend on the previous integrator state. The γ function typically operates as a scaling function of the step size h, while v₁ represents method-dependent offset vectors. The specific values of these parameters vary according to the integration method employed. For instance, implicit Euler uses γ(h)=h and v₁=−uₙ, while the second-order backward differentiation formula method employs γ(h)=6/11 h and v₁=((18/11)*uₙ−(9/11)uₙ₋₁+2/11 uₙ₋₂).

At sub-step 106, updating the state y may include calling a nonlinear solver to calculate the solution to the reduced canonical form G(x; v₁, v₂, c, γ)=v₁+M x−y f(x+v₂,tₙ+ch). This reduced canonical form is a compressed state representation. Sub-step 106 executes the nonlinear solver calculation to determine the solution to the reduced canonical form. This reduced canonical form operates as a compressed state representation that maintains some mathematical relationships while eliminating redundant computational dependencies. The nonlinear solving process typically employs Newton-Raphson methods or related iterative techniques, but operates on the reduced system of size m rather than the original system of size n, where m<n. This reduction in system size directly impacts the computational complexity, changing the scaling from O(n³) to O(m³) for the matrix factorization operations commonly used in Newton methods.

At sub-step 108, the ‘x’ solution is used to compute the step value ‘k’ for the nonlinear state vector y. Sub-step 108 uses the solution x obtained from the nonlinear solve to compute the step value k for the nonlinear state vector y. This step value represents the update increment that will be applied to advance the solution from the current time point to the next time point in the integration sequence. The computation of k incorporates the specific discretization formulas associated with the chosen integration method and ensures that the compressed representation maintains consistency with the underlying differential equation dynamics.

Optionally, at sub-step 110, the method includes decompressing the compressed representation to compute the representation of the solution vector u and the uncompressed k representation of the solver. If this optional step is taken, it is appreciated that steps 112-124 act on the decompressed state u instead of the compressed state u. The optional sub-step 110 provides decompression capabilities that reconstruct the complete system representation when required. This decompression process uses the inverse mapping N⁻¹(y, γ, v₁, v₂)=x to transform from the nonlinear solver state back to the differential algebraic equation state. The decompression step becomes necessary when subsequent computational phases require access to the full system state, such as for explicit update calculations in implicit-explicit methods or for specific output requirements. The system implements compressed dense output state decompression on demand, allowing users to access either the compressed representation for computational efficiency or the decompressed state for comprehensive analysis.

For integration methods that involve multiple stages, such as the KenCarp4 method described in the document, step 102 may be executed multiple times with different parameter configurations. Each stage uses the same canonical form G but with modified values of v₁, v₂, c, and γ corresponding to the specific stage requirements. This approach enables a single optimized compiled function to support all stages of multi-stage integration methods while maintaining the computational advantages of the compressed representation.

The method then moves to step 114 unless optional step 112 is desired.

Optionally, after step 102, step 112 may include computing: the error estimator E, the next h from the controller, and the work estimate W on the compressed state y. The custom error estimator functions E(k), W(k), and newh(k), which are specific to the model, may be provided by the compiler.

Step 112 may include a computational assessment phase that determines the accuracy, efficiency, and progression parameters for the differential equation solving process. This optional step operates on the compressed state y and provides feedback mechanisms that enable adaptive time-stepping and order selection capabilities within the canonical form framework.

The error estimator computation may be designated as E(k) and may evaluate the local truncation error based on the step values k derived from the compressed representation. The error estimation process in the compressed vector form differs from conventional approaches because the difference from the embedded integration method is computed on the compressed subset of the state rather than the complete system. This modification occurs naturally when the internal computations operate on the compressed state representation, effectively subsetting the error estimator to focus on the variables identified through the symbolic optimization process.

The compressed error estimation approach may address specific mathematical challenges associated with differential algebraic equation systems of higher index. In conventional stepping processes, local truncation error estimators may not converge to zero as the step size h approaches zero for algebraic variables in higher-index differential algebraic equations, which can adversely affect adaptive time-stepping schemes. The compressed representation enables the generation of customized model-specific error estimator functions E(k) that exclude higher-index algebraic variables from the error computation, thereby improving the convergence properties of the error estimator and enabling more reliable adaptive behavior.

The work estimate function W(k) may provide computational cost assessment for the nonlinear solving operations. Traditional work estimation approaches assume that solver steps exhibit linear cost scaling with respect to the number of equations, while Newton-based nonlinear solves demonstrate approximately cubic cost scaling due to matrix factorization requirements. The work estimate for a conventional step typically scales as O((n+m)³) where n and m represent the sizes of different variable groups in the system. However, the symbolic optimizations performed through the canonical form approach disclosed herein alter this computational complexity structure.

The compressed representation work estimation may account for the modified computational requirements of the reduced nonlinear system. Rather than solving a system of size n, the optimized process operates on a system of size m where m<n, resulting in computational work that scales approximately as O(m³). This complexity reduction is achieved through the symbolic analysis performed by the compiler system, which identifies mathematical relationships that enable variable elimination from the computational process. The resulting work estimate provides more accurate computational cost predictions that reflect the actual processing requirements of the compressed representation.

Symbolic optimization techniques may further modify the work estimation through strongly connected component decomposition. When the block lower triangular algorithm decomposes the remaining Newton solve into strongly connected components that are solved successively, the work estimate can be reduced beyond the O(m³) scaling. This occurs because the solver becomes a successive application of multiple smaller Newton solves, which typically requires less computational effort than a single large Newton solve due to the greater-than-linear scaling characteristics of matrix factorization operations.

The step controller function newh(k) may compute the next step size based on the error estimates, work assessments, and integration method requirements. Step size controllers in adaptive integration methods are often intimately connected to the specific integration algorithm, particularly for adaptive order integrators where order changes may influence the predicted step size. The compressed representation approach uses customized step controller functions that account for the modified work estimates and error characteristics resulting from the symbolic optimization process.

The step controller may coordinate multiple factors including the computational efficiency gains from the compressed representation, the modified error propagation characteristics, and the specific requirements of the chosen integration method. For methods supporting adaptive order selection, the controller evaluates multiple potential combinations of step size and order to determine the progression strategy. This evaluation process incorporates the model-specific work function W(k) to assess the computational cost implications of different choices and the error function E(k) to ensure accuracy requirements are maintained.

The compiler may generate these model-specific functions E(k), W(k), and newh(k) through symbolic analysis of the particular differential equation system being solved. This generation process considers the specific mathematical structure of the compressed representation, the characteristics of the chosen integration method, and the computational requirements of the target hardware platform. The resulting functions are optimized for the specific model under consideration and provide more accurate assessments than generic estimation approaches that do not account for the symbolic optimization transformations.

The computational efficiency of step 112 may also benefit from the compressed representation through reduced memory access requirements and improved cache utilization. The assessment functions operate on the compressed state y rather than the full system state, resulting in decreased memory bandwidth utilization and more efficient processor cache usage. The specialized data structures employed for the compressed representation, including contiguous memory regions for strongly connected components and optimized memory layouts, contribute to improved computational performance during the error estimation and work assessment phases.

Step 112 may provide feedback mechanisms for the subsequent step acceptance or rejection decision. The computed error estimate E determines whether the current step meets the specified accuracy tolerances, while the work estimate W and step size newh(k) guide the selection of parameters for subsequent integration steps. This information allows the system to dynamically adjust computational parameters based on solution behavior and maintain efficiency throughout the integration process.

At step 114, using the step values, both the value yₙ₊₁, and the computed values E and W are updated. Step 114 may include the systematic updating of solution values and computational assessment parameters based on the step values determined through the nonlinear solving process. This update phase may consolidate the results from the canonical form calculations and prepare the system state for the subsequent step acceptance or rejection evaluation.

This step may involve updating the value y_{{n+1}}, which represents the advanced nonlinear solver state at the next time point. This update incorporates the step values k computed in step 108, applying the appropriate integration formula to advance the compressed state from the current time tₙ to the target time t_{{n+1}}. The specific update mechanism depends on the integration method employed, with different methods utilizing distinct combinations of current and previous step values to compute the next state.

The updating process may operate directly on the compressed representation y rather than the full differential algebraic equation state x. This approach maintains computational efficiency by avoiding the expansion to the complete system representation during intermediate calculations. The compressed state y contains the variables identified through symbolic optimization, allowing the update operations to proceed with reduced memory access requirements and improved cache utilization patterns.

The computed error estimate E may be updated simultaneously with the solution values to reflect the accuracy assessment for the current integration step. This error update incorporates the model-specific error function E(k) generated by the compiler, which accounts for the modified error propagation characteristics resulting from the compressed representation. The updated error estimate serves as a criterion for determining whether the current step meets the specified accuracy tolerances.

The work estimate W may be updated to reflect the actual computational effort expended during the current integration step. This update process compares the predicted computational cost from the model-specific work function W(k) with the observed computational requirements, providing feedback that can improve future work estimations. The updated work estimate contributes to subsequent step size and order selection decisions by providing accurate computational cost information.

The updating mechanism may incorporate multiple integration stages when the chosen method requires successive nonlinear solves. For methods such as the KenCarp4 approach described in the document, multiple calls to the canonical form G may be required with different parameter configurations for each stage. The update process coordinates these multiple stages, ensuring that intermediate results are properly accumulated and that the final y_{{n+1}} value reflects the complete integration step.

The step value accumulation may follow the specific mathematical structure defined by the integration method's discretization formulas. For backward differentiation formula methods, the update process incorporates contributions from multiple previous time points with method-specific coefficients. For Runge-Kutta methods, the update combines contributions from multiple stages within the current time step, with each stage contributing according to the method's tableau structure.

The update process may maintain compatibility with dense output requirements by preserving the step values k and integrator-specific parameters γ and v₁. These values enable the subsequent reconstruction of solution information at intermediate time points within the current integration step. The compressed representation allows this information to be stored efficiently while providing the flexibility to decompress the complete solution when required.

Error propagation considerations may influence the numerical precision maintained during the update operations. The system employs appropriate numerical techniques to minimize accumulated rounding errors and maintain solution accuracy throughout the integration process. The compressed representation can reduce the number of floating-point operations required for the updates, thereby limiting the accumulation of numerical errors compared to full-system approaches.

The updated values y_{{n+1}}, E, and W may be prepared for use in the subsequent step acceptance or rejection decision. The formatting and organization of these values follows the requirements of the step evaluation logic, ensuring that the acceptance criteria can be applied efficiently. The compressed representation maintains consistency with the error tolerances and computational constraints specified for the overall integration process.

The step may then be either rejected or accepted. If the step is rejected, the time step may be decreased, the order may optionally be changed, and the method returns to step 102. Alternatively, if the step is accepted, it is updated and the method returns to step 100.

Steps 116, 118, and 120 may include the decision-making and branching logic that determines the progression path following the solution and assessment value updates completed in step 114. This decision framework evaluates the computed error estimates against specified accuracy tolerances and directs the integration process along appropriate computational pathways based on the assessment results.

Step 116 may include an acceptance evaluation that compares the updated error estimate E against the prescribed accuracy criteria for the integration process. This evaluation determines whether the current integration step achieves accuracy to warrant acceptance or should be rejected and recomputed with modified parameters. The decision logic incorporates the error tolerances specified for the differential equation system and applies appropriate comparison criteria that account for the compressed representation characteristics.

The acceptance criteria may use both absolute and relative error tolerance specifications that govern the precision requirements for the integration process. The compressed representation approach affects these tolerance evaluations because the error estimate E operates on the reduced variable set rather than the complete system state. The decision logic accounts for this modification by applying tolerance criteria that reflect the mathematical significance of the compressed variables within the overall system dynamics.

Step 118 may include the rejection pathway that activates when the error estimate exceeds the specified tolerance thresholds. The rejection process initiates parameter modifications designed to improve accuracy in subsequent integration attempts. The primary adjustment involves decreasing the time step size h, which typically reduces local truncation error and improves the likelihood of meeting accuracy requirements in the next iteration.

The time step reduction mechanism may employ established step size adjustment algorithms that balance computational efficiency with accuracy requirements. The reduction factor depends on the magnitude of the error estimate relative to the tolerance specifications, with larger errors prompting more substantial step size decreases. The model-specific step controller function newh(k) generated by the compiler provides guidance for selecting appropriate new step sizes based on the specific characteristics of the compressed representation.

Order modification may be included optionally within the rejection pathway for integration methods that support adaptive order selection. The order adjustment process evaluates whether changing the integration method order might provide better computational efficiency or accuracy characteristics for the current solution region. This evaluation incorporates the model-specific work function W(k) to assess the computational cost implications of different order choices.

The rejection pathway may direct the integration process to return to step 102 with the modified parameters. This return initiates a new solver step using the adjusted time step size and potentially modified order, while maintaining the current time point and solution state. The compressed representation allows this iteration to proceed efficiently by preserving the system information in the reduced state y.

Step 120 may include the acceptance pathway that activates when the error estimate satisfies the specified tolerance requirements. The acceptance process confirms that the computed solution y_{{n+1}} provides adequate accuracy and advances the integration to the next time point. This advancement updates the current time from tₙ to t_{{n+1}}; and establishes y_{{n+1}} as the new current state for subsequent integration steps.

The acceptance pathway may include solution state advancement that formally commits the computed values as the new system state. This commitment process updates internal variables and data structures to reflect the successful integration step and prepares the system for the next integration iteration. The compressed representation maintains efficiency during this advancement by operating on the reduced variable set while preserving the capability to reconstruct complete system information when required.

The acceptance process may direct the integration to return to step 100 for the next pre-solver setup phase. This return initiates the computational cycle for the subsequent time step, beginning with the determination of new proposed time step sizes and integration parameters. The adaptive capabilities of the system allow these parameters to be modified based on the computational experience gained during the completed step.

Parameter updating may occur within the acceptance pathway to optimize future integration performance. The system may adjust default step sizes, modify order preferences, or update computational cost estimates based on the observed performance characteristics of the completed step. These adjustments use the feedback provided by the work estimate W and step controller function newh(k) to improve computational efficiency in subsequent iterations.

Now referring to FIG. 1B, steps 122 or 124 may then be performed automatically after the step is accepted or rejected or may be performed on-demand as requested by the user. For non-dense outputs, step 122 may use the inverse mapping N⁻¹(y) to reconstruct x using the state value y.

Step 122 may include the reconstruction of the complete differential algebraic equation state from the compressed representation for non-dense output applications. This reconstruction process uses the inverse mapping function N⁻¹(y) to transform the compressed nonlinear solver state y back to the full system state x, enabling access to all system variables when required by the user or subsequent computational processes.

The inverse mapping function N⁻¹ may be generated by the compiler during the symbolic optimization phase and serves as the mathematical transformation that reverses the compression performed by the forward mapping N(x)=y. This inverse transformation reconstructs the complete vector of differential and algebraic variables from the reduced variable set maintained during the compressed solving process. The reconstruction maintains mathematical consistency with the original system representation while leveraging the computational efficiency gains achieved through the compressed representation approach.

The timing of step 122 execution may be configured to occur either automatically following step acceptance or rejection, or on-demand based on specific user requirements. The automatic execution mode provides immediate access to the complete system state whenever a solution step is completed, ensuring that full system information remains available for subsequent analysis or output generation. The on-demand execution mode allows users to request complete state reconstruction when needed, thereby maintaining computational efficiency by avoiding unnecessary decompression operations.

The reconstruction process may operate using the state value y that represents the solution at the current time point following the integration step. The inverse mapping applies the mathematical relationships identified during the symbolic optimization process to compute the values of all system variables from the reduced set of variables maintained in y. This computation process varies in complexity depending on the specific mathematical structure of the differential equation system and the nature of the symbolic optimizations applied during compilation.

Simple reconstruction cases may involve direct subsetting operations where the inverse mapping extracts specific variable values from the compressed state and computes remaining variables through explicit algebraic relationships. The example provided in the document illustrates this approach with the mapping N⁻¹(u[2], γ, v₁, v₂, c)=[γ u[2]−v₁[1]−v₂ [1], u[2]], where the first component is computed algebraically from the second component and the integrator-specific parameters.

Other reconstruction scenarios may involve nonlinear function evaluations when the symbolic optimization process employs analytical solutions or symbolic manipulation techniques. The inverse mapping N⁻¹ can represent a general nonlinear function that accounts for the mathematical transformations applied during the compression phase. These reconstructions maintain solution accuracy while providing access to the complete system state information.

The reconstruction process may incorporate the integrator-specific parameters γ, v₁, and v₂ that encode the current integration step characteristics. These parameters influence the inverse transformation by providing the mathematical context required to accurately reconstruct the full system state from the compressed representation. The integration method and current step parameters affect the reconstruction calculations and ensure consistency with the underlying discretization approach.

Or, for dense outputs, step 124 may use the dense output vectors generated from y at intermediate time points rather than state value y.

Step 124 may include the reconstruction of continuous solution information using dense output vectors generated from the compressed state y at intermediate time points within the integration interval. This dense output capability provides solution values at arbitrary time points between the discrete integration steps, enabling analysis of solution behavior and high-resolution output generation without requiring additional integration steps.

The dense output vector approach may use precomputed interpolation information derived from the compressed representation during the integration process. Unlike the non-dense output reconstruction in step 122 that operates on the final state value y, this approach uses intermediate computational results and step values k that capture the solution dynamics throughout the entire integration step. The dense output vectors contain the mathematical information required to accurately approximate the solution at any time point within the current integration interval.

The interpolation process may operate using the integrator-specific dense output functions that correspond to the chosen integration method. Different integration approaches provide varying levels of dense output capability, with higher-order methods typically offering more accurate interpolation properties. The system supports dense output generation for implicit Runge-Kutta methods, backward differentiation formula methods, and other integration approaches through method-specific interpolation algorithms that maintain consistency with the underlying discretization characteristics.

The compressed representation approach may enhance dense output efficiency by reducing the computational and storage requirements for interpolation operations. The dense output vectors operate on the compressed state y rather than the full system state x, resulting in decreased memory utilization and improved computational performance during interpolation calculations. The reduction in interpolation complexity scales proportionally with the compression ratio achieved through the symbolic optimization process.

The mathematical foundation for dense output reconstruction may rely on the preservation of step values k and integrator-specific parameters γ(ρh) and v₁ during the integration process. These values encode the solution dynamics information required for accurate interpolation within the current step interval. The parameter ρ represents the fractional position within the step interval, with ρ=0 corresponding to the beginning of the step and ρ=1 representing the end of the step.

The interpolation accuracy may depend on the linearity properties of the γ(h) function with respect to the step size h. The reconstruction works effectively when γ(h) exhibits linear dependence on h, which applies to subsets of general linear methods that isolate the nonlinear system to a single stage at a time. Methods such as singly diagonally implicit Runge-Kutta and backward differentiation formula approaches satisfy this linearity requirement and provide reliable dense output capabilities.

Some integration methods may require extended interpolation procedures that incorporate additional step information beyond the standard k values. For methods where γ(h) does not exhibit linear behavior, the interpolation process may compute extended k values before performing the dense output reconstruction. These extended values capture the nonlinear relationships present in the integration method and ensure accurate interpolation throughout the step interval.

The reconstruction computation may proceed by first determining the compressed state value at the desired intermediate time point t+ρh using the integrator-specific dense output function. The system then applies the transformation computation with the parameter γ(ρh) to generate the appropriate interpolated values. This two-stage process maintains the mathematical relationships established during the integration step while providing access to solution information at the requested time point.

Next, at step 126, the dense output may be saved using the compressed state. This may include saving the values γ(ρ) and v₁ with the state y and the step values k, which allows for reconstruction of the continuous output on demand.

Step 126 may include the storage of dense output information using the compressed state representation to enable efficient preservation of continuous solution data. This storage phase consolidates the interpolation-capable information generated during the integration process into a compact format that supports on-demand reconstruction of solution values at arbitrary time points within the integration interval.

The storage process may incorporate the compressed state y as the primary solution information, along with the integrator-specific parameters γ(ρ) and v₁ required for accurate dense output reconstruction. The system preserves these parameters alongside the step values k, creating a complete dataset that contains all mathematical relationships required for subsequent interpolation operations while maintaining the interpolation accuracy characteristics of the original integration method.

The compressed storage approach may reduce memory requirements compared to conventional dense output storage methods which often require preservation of complete system state information at multiple time points, by using the compressed representation to store the needed variables and parameters. This reduction in memory allocation requirements scales proportionally to the compression ratio achieved through symbolic optimization.

The solver process described above may be illustrated using the example the case described by the inline integration authors for the two-part ODE system below:

$${u}_{1}^{′} = {u}_{2}$$

$${u}_{2}^{′} = f ( {u}_{1} , {u}_{2} , t )$$

For this ODE, the compiler described herein would perform the symbolic manipulations would build the nonlinear system of the canonical form G(x; v₁, v₂, c, h)=v₁+M x−γ(h) f(x+v₂, tₙ+ch) (with M=I the identity matrix):

$$0 = {v}_{1} [ 1 ] + u [ 1 ] - γ u [ 2 ] + {v}_{2} [ 1 ]$$

$$0 = {v}_{1} [ 2 ] + u [ 2 ] - γ f ( u [ 1 ] + {v}_{2} [ 2 ] , u [ 2 ] , t )$$

and by substitution notice:

$$u [ 1 ] = γ u [ 2 ] - {v}_{1} [ 1 ] - {v}_{2} [ 1 ]$$

$$0 = {v}_{1} [ 2 ] + u [ 2 ] - γ f ( γ u [ 2 ] - {v}_{1} [ 1 ] - {v}_{2} [ 1 ] + {v}_{2} [ 2 ] , u [ 2 ] , t )$$

Thus, the reduced nonlinear system is simply to solve the second equation for u₂, and u₁ can be generated from the u₂ portion. Because of this, there is the mapping N(u)=u[2] and N⁻¹ (u[2], γ, v₁, v₂, c)=[γ u[2]−v₁[1]−v₂[1], u[2]]=u as the mapping to and from the state vector of the original DAE and the nonlinear solver's state representation.

The compiler generates the reduced canonical form function G(u[2]; v₁, v₂, γ, c)=0=v₁ [2]+u[2]−γ f(γ u[2]−v₁ [1]−v₂ [1]+v₂ [2], u[2], t+h) and the mapping functions N and N⁻¹. Then when a general ODE solver is called, instead of solving the ODE on u, the solver changes to subsetting it to only solve the ODE on u[2] via the mapping N. Thus, calls to the nonlinear solver instead solve the reduced canonical form. The stepper thus only computes the updates on u[2], though with this information u[1] and thus u (via N⁻¹) can be recomputed on-demand.

It may be appreciated that, for non-solver specialized dense output, the k values may be modified. For example, in Hermite interpolation the k values would be f(γ(h) u[1]−v₁[1], u[1], t+h) at the beginning and end of the interval.

For the dense output, the value at ut+ρ for ρ in [0,1] may be computed by first reconstructing the compressed state value at t+ρ h using the integrator-specific dense output function, and then using the transformation computation with γ(ρh). One can show that this reconstruction process works if γ(h) is a linear function of h, which for subsets of general linear methods which isolate the nonlinear system to a single stage at a time (such as (E)SDIRK methods, BDF methods, etc.) this is the case. For other methods, interpolation may require computing the extended k values before performing the dense output.

It may be appreciated, however, that performing the full solver process in the compressed representation is not necessary for the generalized symbolic-numeric optimizations described herein. For example, sub-step 106 may optionally further include performing the inverse mapping N⁻¹. Using this, the k values would be expressed in the original variable representation, i.e. derivative estimates of the full u. However, the compressed representation decreases the overall memory and compute cost. However, by doing the compression, the integrator's mathematics is actually modified to not guarantee the same behavior for error estimation, step-size and order control without further modifications. The next section details that such modifications can be rigorously mathematically justified as beneficial behavior.

The computational efficiency improvements achieved through the compressed representation can be quantified through specific technical metrics. In systems where the original differential equation system contains n equations and the compressed representation reduces the nonlinear solve to m variables where m<n, the memory allocation requirements decrease proportionally from n to m for the primary computational vectors. For example, in a system with 10,000 original equations that compresses to 3,000 variables, the memory requirements for the core solver operations are reduced by approximately 70 percent, with corresponding reductions in cache miss rates and memory bandwidth utilization.

The parallelization capabilities enabled by the strongly connected component decomposition provide additional concrete performance improvements. When the compiler generates a directed acyclic graph structure for the nonlinear solves, independent components can be processed simultaneously on multi-core processor architectures. In systems with multiple independent strongly connected components, the wall-clock computation time approaches the time required for the largest single component rather than the sum of all component processing times. This parallelization is particularly effective on modern server architectures with high core counts, where the parallel efficiency can exceed 80 percent for well-decomposed systems.

The elimination of solver-specific implementations provides measurable benefits in software development and maintenance overhead. Traditional inline integration approaches require separate code implementations for each discretization method, typically resulting in 5 to 10 distinct solver variants for comprehensive scientific computing applications. The unified canonical form approach described herein reduces this to a single optimized implementation that supports many implicit integration methods, decreasing code base size by approximately 80 to 90 percent while improving consistency and reducing potential for implementation errors across different numerical methods.

The adaptive time-stepping and order selection capabilities represent technical advances over existing inline integration implementations. Current systems are limited to fixed time steps and fixed order methods, which can result in either excessive computational overhead from unnecessarily small time steps or accuracy degradation from inadequate time resolution. The adaptive capabilities enabled by the compressed representation allow dynamic adjustment of computational parameters based on solution behavior, typically reducing total computation time by 30 to 60 percent for problems with varying stiffness characteristics while maintaining specified accuracy tolerances.

Note that in the given example the compression function N is simply to subset the original vector, i.e. N([u[1], u[2]])=u[2]. This is not necessarily the case for all models. For example, the subset states computed via tearing could be given as linear combinations of the linear states. In general, this (and the N⁻¹ transform) could be a nonlinear function if symbolic analytical solutions are employed in the simplification process.

### Transformed Solver Behavior in the Context of Symbolic-Numeric Nonlinear Solver Optimizations Via Canonical Forms in Compressed Representation

As detailed before, all current solvers that support inline integration only support non-adaptive fixed time step and fixed order integration. Thus, there is no precedence for describing how adaptivity should occur in the context of inline integration. With the General Symbolic-Numeric Nonlinear Solving in Implicit Differential Equation Solvers via Canonical Forms in Compressed Representation described herein, however, if the optional decompression step is omitted, the solver's properties are no longer computed the same as in the case without inline integration.

As will be shown below, the adaptivity algorithm described herein is valid and can be mathematically-justified.

For order adaptivity, the order choice is determined using the elements of step 112, namely the error estimate E, the work estimate W, and the suggested h via some controller process. For the work estimate, since most of the solver steps are linear cost with respect to the number of equations and while for example a Newton solve has approximately a cubic cost due to the LU factorization. Because of this, the work estimate for a step is computed by approximating the potential cost of the nonlinear solve. However, with the symbolic optimizations performed by the inline integration, this work estimate is no longer reliable since the complete Newton method is not used. In our example with (u₁,u₂) being size n and m, the naive work estimate would be O((n+m)³), while the inline integration process builds a nonlinear solve with approximate work more akin to O(m³). If the standard work estimate process is applied to the compressed state y=u₂, however, a more corrected error estimate is received.

Note that in general the work estimate may be more complex. For example, if the algorithm decomposes the remaining Newton solve into strongly connected components (SCCs) which are successively solved, then the work estimate could be further reduced as the solver becomes the successive application of many smaller Newton solves, which is likely to be less than the original cost because of the greater than linear scaling of Newton method costs. Thus, the compiler for a given model may provide a model-specific work estimate determined by the generated nonlinear solve process.

Additionally, the error estimate in the compressed vector form is different from the original solver because the difference from the embedded method is computed on the compressed subset of the state. This difference may be illustrated by discussing how moving the internal computations on the compressed state representation affects convergence of a local truncation error estimator, where the local truncation error estimator may not be convergent to zero as h goes to zero for all the algebraic variables if the DAE is higher than index one.

A convergent local truncation error estimator may be desirable for an adaptive time stepping scheme because otherwise decreasing h may not decrease the error estimate E, and an adaptivity scheme can thus not guarantee a method to achieve improved accuracy. Note that this also adversely effects other properties such as zero-stability and global convergence.

In contrast to the original stepping process where local where truncation error is not convergent, for the stepping modified by inline integration it is no longer necessarily the case that local truncation error is not convergent. However, the local truncation error estimator of the original stepping process may still be non-convergent on the higher index algebraic variables. One way to make the local truncation error of the stepping process convergent is to generate a customized model-specific error estimator function E(k) which subsets the normal error estimate to exclude the higher index algebraic variables. This allows the compiler to generate E(k) and improve the general solver process after symbolic simplification of the nonlinear solve.

However, by moving the internal computations on the compressed state representation, the error estimator also naturally changes its computational. In cases such as the [u₁, u₂] example discussed above, these changes would subset the error estimator to be only the error with respect to the stepping of the u₂ values, because the u₁ values are treated as exact reconstructions from this subprocess. In many cases it can be shown that this will allow for automating the elimination of the higher index algebraic variables and thus improve the error estimator. However, such an approach is possibly more general since, as mentioned before, N may be a more complex function (it may not simply be a subsetting function and instead a general nonlinear equation).

The performance monitoring infrastructure embedded within the solving system provides real-time measurement of computational efficiency metrics that guide adaptive optimization decisions. The system tracks cache miss rates, instruction throughput, memory bandwidth utilization, and floating-point operation efficiency to assess the effectiveness of the compressed representation during actual computation. These measurements are collected using hardware performance counters available on modern processor architectures, providing precise quantification of the computational improvements achieved through the canonical form approach. The monitoring system also implements statistical analysis algorithms that identify performance bottlenecks and suggest algorithmic adjustments to optimize resource utilization for specific problem characteristics.

In addition, the step size controller may be, in many cases, intimately tied to the integration algorithm. This is especially true for cases which involve adaptive order integrators since adapting the order may change the predicted next step size. Thus, like the error estimator and the work estimate, the compiler may provide an alternative step controller function that accounts for the modified work and the modified error estimate in order to choose the new step size and potentially new order effectively.

### Canonicalization for IMEX Additive Runge-Kutta Methods

In the context of additive Runge-Kutta methods for Implicit-Explicit (IMEX) integration, the ODE may be in a split form u′=f₁(u,t)+f₂(u,t) where f₁ is handled implicitly and f₂ is handled explicitly. In this form, all of the solver steps described herein would apply to the canonical form G(x; v₁, c, h)=v₁+M x−γ(h) f₁(x, tₙ+ch). It is appreciated, however, that the decompression stage 110 may be performed when, as in this case, the explicit update is computed using the decompressed state.

### Block-Array Canonicalization for Fully-Implicit Runge-Kutta Methods

While the canonicalization described herein works for the implementation of all integration methods that isolate the nonlinear solve per each stage, that canonicalization excludes fully-implicit Runge-Kutta methods (FIRK) such as RadauIIA implementations.

While at face value this may seem to inhibit canonicalization, the block-algebraic structure can be exploited in order to give a canonicalization. Using linear algebra, the canonical form of the FIRK method can be expressed as:

$$G ( x ; {v}_{1} , A , S ) = I ⊗ {v}_{1} + I ⊗ Mx - hA ⊗ F ( x )$$

Where ⊗ is the Kronecker product and A is the tableau matrix which defines the FIRK method. An aspect about this form is that the size of the chosen identity matrix I matches the size of the tableau A, and under that size restriction this representation holds for all FIRK methods.

S can thus be defined so that A is an S×S matrix and I is an S×S matrix. A symbolic simplification engine supporting arbitrarily-sized S×S arrays can then perform simplifications on this canonical form to generate a single optimized function for any size S. These simplifications can include performing the symbolic simplifications within a block and allowing for S repeated blocks in the generated code (represented by some form of loop, iteration, or map). The resulting compiler target to this form is thus independent of the tableau size of the FIRK method (and thus the order), as that size simply would be supplied in the parameters to G passed into sub-step 106.

Note that this method can also be applied without block-array canonicalization by specializing the canonical form on S and applying the symbolic-numeric optimizations on a per-S basis. This would give a simpler form to the handling of FIRK methods, which can be mixed with the compressed representation handling to give a generalization of previous inline integration schemes to allow for a general Radau solver to be used with order-specific FIRK-optimized nonlinear solves. An adaptive order scheme Radau scheme in this form could thus be implemented by compiling G with multiple values of S and choosing the symbolic-numeric optimized G on-demand during the stepping process by checking the S size given by the current order.

### Parallelized Strongly Connected Component Codegen and Runtime

The condensation graph of the strongly connected components induced from the bipartite graph of equations and variables in a nonlinear system exactly encodes the dependence relationships among all the decomposed individual nonlinear solves. Since the condensation graph must be a directed acyclic graph (DAG), all the nonlinear solves can be computed in parallel if all of their immediate predecessors are solved.

This DAG structure maps well to a runtime with task-based parallelism. To achieve parallel execution, all the individual nonlinear solves can be spawned in the topologically sorted order of the condensation graph and insert wait statements for all its immediate predecessors before each spawn. To coordinate the information flow of the SCC solves, each parallel nonlinear solve will write to a memory buffer that has the same lifetime as the RHS function of the global nonlinear system. To avoid false sharing, all the variables in a single SCC are arranged to a contiguous region in the memory buffer, while all the contiguous regions must be separated far enough in memory to eliminate the possibility of false sharing.

In one embodiment, the parallel execution implementation uses work-stealing task schedulers that dynamically balance computational load across available processor cores. Each strongly connected component solve operation is encapsulated as an independent task with explicitly defined dependencies corresponding to the edges in the directed acyclic graph. The task scheduler maintains separate work queues for different priority levels, ensuring that some path computations receive preferential scheduling while maintaining overall system throughput. The implementation includes non-uniform memory access (NUMA)-aware memory allocation strategies that minimize cross-socket memory access overhead on multi-processor systems, particularly for large-scale scientific computing applications that use high-performance computing clusters.

The synchronization mechanisms for coordinating parallel strongly connected component solves employ lock-free data structures and atomic memory operations to minimize contention overhead. The system uses memory barriers and acquire-release semantics to ensure correct ordering of memory operations across different processor cores. For communication between parallel tasks, the implementation employs message-passing interfaces that leverage processor-specific features such as cache coherency protocols and memory consistency models to optimize data transfer efficiency. The parallel execution framework also includes load monitoring capabilities that track per-core utilization and automatically adjust task granularity to maintain processor occupancy.

Since not all SCC is necessarily nonlinear, to avoid repeating solving the same linear SCC problem multiple times in its dependencies, the explicit calculations are interleaved with nonlinear SCC solves.

### Symbolic-Numeric Linear Optimizations for Semi-Implicit Integrators

While the discussion above centered on symbolic-numeric optimizations of nonlinear equations for implicit solvers, semi-implicit methods, such as Rosenbrock methods, do not benefit from the previous formulation. In these semi-implicit methods, the Jacobian is used directly even though the complete nonlinear system is not solved. They are tantamount to a special form of the implicit solvers—but with a single step of the Newton method designed in such a manner that this gives higher order convergence without requiring convergence of the nonlinear system.

Below is a formulation for the compiler targeting to generalize to semi-implicit methods.

$$G ( x ; v , b , {v}_{1} , {v}_{2} , c , γ ) = ( {v}_{1} + M v - γ {f}^{′} ( v + {v}_{2} , {t}_{n} + ch ) ) x - b$$

This canonical form only uses f′, i.e. the Jacobian ∂f/∂u and not f directly, and thus this canonical form G(x;v,b,v₁,v₂,c,γ) is linear with respect to the solution variable x. Nonetheless, symbolic simplification tools can simplify the linear solve into subsets of equations, specializing on features like the sparsity pattern and reordering, using the symbolic information of f′ before the solution, and as such this canonical form would thus be swapped in for 2.s.2 for a similar extension to semi-implicit methods.

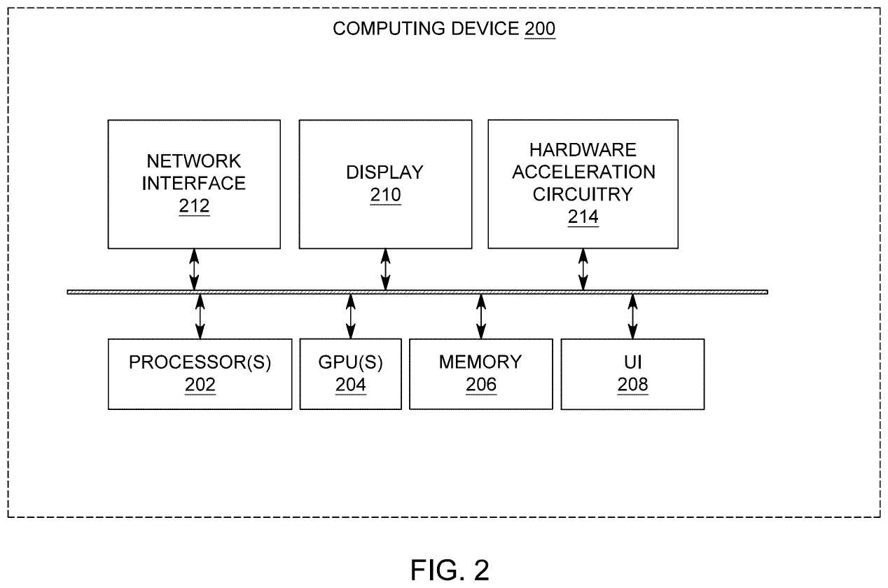

FIG. 2 depicts a block diagram illustrating one embodiment of a computing device that implements the methods and systems described herein. Referring to FIG. 2, the computing device 200 may include at least one processor 202, at least one graphical processing unit (“GPU”) 204, a memory 206, a user interface (“UI”) 208, a display 210, a network interface 212, and hardware acceleration circuitry 214. The memory 206 may be partially integrated with the at least one processor 202, the GPU(s) 204, and/or the hardware acceleration circuitry 214. The hardware acceleration circuitry 214 may be specialized circuitry or hardware specific circuitry, such as an ASIC or FPGA. The UI 208 may include a keyboard and a mouse. The display 210 and the UI 208 may provide any of the GUIs in the embodiments of this disclosure.

The methods described herein may be implemented on one or more computing devices, such as the computing device described in the context of FIG. 2. In one embodiment described herein, a compiler system is disclosed. The compiler system includes one or more hardware processors operable to solve nonlinear problems in implicit differential equations. This includes representing a set of one or more differential equations in a reduced canonical form: G(x; v₁, v₂, γ,c)=v₁+Mx−γ(h) f(x+v₂,tₙ+ch) and generating model-specific functions G, N, N⁻¹ to the reduced canonical form. A mapping N(x)=y determines a nonlinear solver state y from a DAE state x. A mapping N⁻¹(y, γ, v₁, v₂)=x determines DAE state x from nonlinear solver state y. Functions v₁, v₂, and γ(ρh) are integrator-specific functions of a previous integrator state. The system determines a solution to the reduced canonical form by determining a nonlinear solver state y for a differential-algebraic equation (DAE) state x and determining a step value for a nonlinear state vector using the solution to the reduced canonical form.

The system architecture described herein for solving nonlinear problems in implicit differential equations through reduced canonical forms supports numerous specialized configurations that extend its capabilities. These embodiments demonstrate the flexibility and adaptability of the canonical form approach while maintaining the mathematical framework established by the reduced canonical form G(x; v₁, v₂, γ, c)=v₁+M x−γ(h) f(x+v₂, tₙ+ch) and its associated mapping functions N(x)=y and N⁻¹(y, γ, v₁, v₂)=X.

The system architecture supports enhanced computational capabilities through the generation of model-specific functions that customize the solving process for particular mathematical models. These specialized functions include a model-specific work function W(k), a model-specific error function E(k), and a model-specific step controller function newh(k). The work function provides computational cost assessment tailored to the compressed representation characteristics, while the error function delivers accuracy evaluation that accounts for the reduced variable set. The step controller function optimizes progression parameters based on the specific mathematical structure identified during symbolic optimization.

Parallel processing and component decomposition capabilities emerge when the canonical form function G is generated using strongly connected components that organize the nonlinear solving process into manageable computational units. This decomposition approach creates a list of nonlinear solves that may be processed efficiently through structured dependency relationships. The nonlinear solves within these strongly connected components use directed acyclic graph structures that enable parallelization between independent nonlinear solves. This parallel processing capability allows multiple processor cores to work simultaneously on independent equation clusters, improving computational throughput while maintaining mathematical accuracy.

Parameter configuration flexibility allows the system to support various parameter configurations that adapt to different integration methods and mathematical structures. The integrator parameter γ may function either as a function of step size h or as a constant value, depending on the chosen integration approach. Additionally, the system supports configurations where at least one of the integrator-specific functions v₁ and v₂ are encoded as zero values, simplifying the canonical form for particular integration methods and reducing computational overhead.

Specialized system configurations address different types of differential equation systems through targeted optimizations. For ordinary differential equations without mass matrices, the code may be optimized to eliminate unnecessary matrix operations and streamline the computational process. Alternatively, for fully implicit differential algebraic equations, the system supports specialized handling by replacing the mass matrix term Mu with input corresponding to df(u,u′,t)/du′, enabling accurate treatment of the algebraic constraints in such systems.

Dense output capabilities within the system provide comprehensive functionality that enables continuous solution reconstruction at arbitrary time points within integration intervals. The architecture supports decompressing the compressed dense output state on demand, allowing users to access complete system information while maintaining computational efficiency during standard operation. The system may use decompressed dense output state for applications requiring full system visibility and supports Hermite interpolation modifications to dense output for enhanced accuracy in continuous solution reconstruction.

Integration method compatibility demonstrates the broad applicability of the canonical form framework across major classes of implicit integration methods. The system supports implicit Runge-Kutta methods including diagonally implicit Runge-Kutta (DIRK), singly diagonally implicit Runge-Kutta (SDIRK), and Gauss-Radau numerical methods. Support extends to explicit singly diagonal implicit Runge-Kutta (ESDIRK) methods and implicit linear multistep numerical methods including Adams-Moulton methods and backward differentiation formula (BDF) methods. The architecture also supports semi-implicit methods including Rosenbrock methods, demonstrating the versatility of the canonical form approach across different integration paradigms. For fully implicit Runge-Kutta methods, the system supports both fixed order and adaptive order tableaus. The fixed order implementation provides optimized performance for applications with predetermined accuracy, while the adaptive order capability generates multiple specialized canonical form functions G corresponding to different allowed orders. This adaptive order functionality enables dynamic selection of integration order during the solving process, optimizing computational efficiency based on solution characteristics and accuracy.

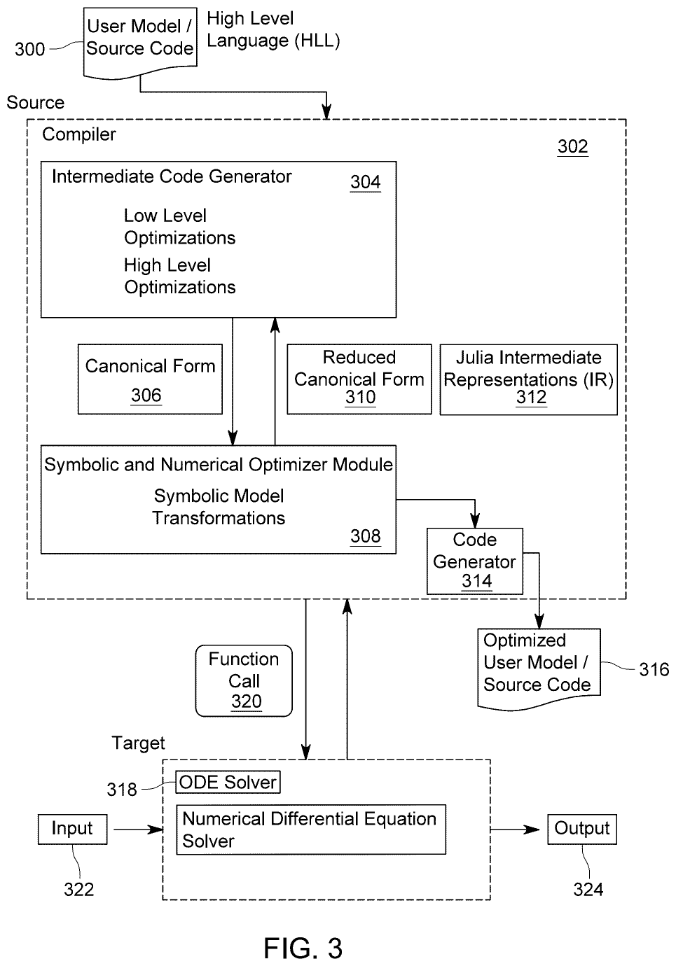

FIG. 3 depicts a block diagram that illustrates the relationship between the compiler infrastructure and the general solver framework according to the canonical form approach described herein. This architectural representation demonstrates how the symbolic-numeric optimization process transforms high-level mathematical models into optimized computational functions that interface with general differential equation solving software, thereby achieving the performance benefits of inline integration without requiring specialized solver implementations.

The architectural flow begins with user model 300, which may be expressed using a high-level modeling language such as JuliaModelingToolkit.jl. This modeling environment supports the representation of complex systems that span multiple physical domains, including mechanical, electrical, electronic, magnetic, hydraulic, thermal, control, and electric power components. The high-level language provides object-oriented constructs that facilitate modular system design and supports acausal connection of components governed by mathematical equations, enabling modeling approaches that derive system behavior from first principles rather than predetermined computational sequences.

The mathematical equations generated through this high-level modeling process typically include systems of ordinary differential equations and differential algebraic equations that capture the underlying physical relationships governing system behavior. These equations serve as the mathematical foundation for the subsequent optimization and code generation processes, providing the symbolic information required for the canonical form transformations.

The compiler 302 implements an optimization pipeline that transforms the high-level mathematical model into efficient computational functions suitable for general solver integration. The compiler architecture includes an intermediate code generator 304 that performs both low-level and high-level optimizations on the input mathematical model. These optimizations encompass symbolic manipulation techniques, algebraic simplification procedures, and computational structure analysis that identify opportunities for performance improvement and mathematical complexity reduction.

The intermediate code generator produces output that includes the input equations reframed into a canonical form 306, representing the first stage of the mathematical transformation process. This canonical form provides a standardized mathematical representation that captures the structure of implicit differential equation solvers while maintaining compatibility with multiple integration methods. The canonical form G(x; v₁, v₂, γ, c)=v₁+M x−γ(h) f(x+v₂, tₙ+ch) serves as the mathematical foundation for subsequent optimization procedures.

The symbolic and numerical optimizer module processes the canonical form representation to generate a reduced canonical form 310 that incorporates the compressed representation techniques described throughout this application. This reduction process applies symbolic analysis to identify algebraically dependent variables and eliminate computational redundancies, resulting in a mathematical representation that operates on a reduced variable set while preserving solution accuracy. The optimization module generates the mapping functions N(x)=y and N⁻¹(y, γ, v₁, v₂)=x that provide the interface between the complete system state and the compressed representation.

The optimization process generates various intermediate representations 312 that capture different aspects of the mathematical transformation and computational structure. These intermediate representations include dependency graphs that encode variable relationships, strongly connected component decompositions that enable parallel processing opportunities, and mathematical expressions that represent the optimized computational procedures. The intermediate representations serve as the foundation for subsequent code generation activities and provide the information required to generate efficient computational implementations.

The code generator 314 transforms the intermediate representations into executable code that implements the optimized mathematical functions. This code generation process produces user model source code 316 that includes the canonical form function G, the mapping functions N and N⁻¹, and the model-specific functions W(k), E(k), and newh(k) when applicable. The generated code incorporates platform-specific optimizations that account for target hardware characteristics, memory hierarchy considerations, and computational efficiency requirements.

The code generation process produces functions that interface with general differential equation solver software through standardized function signatures and calling conventions. This interface design allows the generated functions to integrate with existing solver infrastructures without requiring modifications to the general solver implementations. The generated code maintains mathematical accuracy while providing the computational efficiency benefits achieved through the symbolic optimization process.

The compiler-generated functions integrate with general ODE solver software 318 through specialized function calls 320 that have been optimized by the compiler for the specific mathematical model under consideration. These function calls replace the standard solver operations with the optimized implementations generated through the canonical form approach.

The function hook mechanism enables the general solver to access the benefits of symbolic-numeric optimization without requiring modifications to the solver's core algorithmic structure. The solver continues to implement its standard integration algorithm, but the individual computational operations are performed using the optimized functions rather than generic mathematical procedures. This approach maintains the solver's existing capabilities for adaptive time-stepping, order selection, and error control while providing enhanced computational efficiency for the specific mathematical model.

The specialized function calls encompass the canonical form evaluation, state mapping operations, and model-specific assessment functions generated by the compiler. The general solver invokes these functions at appropriate points in the integration algorithm, utilizing the compressed representation approach to reduce computational complexity while maintaining solution accuracy. The function interface preserves the mathematical relationships required for accurate integration while enabling the solver to operate on the reduced variable set identified through symbolic optimization.

After the specialized function calls are applied by the general solver, the resulting integration process produces output 324 that achieves performance characteristics comparable to inline integration implementations. The integration process benefits from the reduced computational complexity, improved memory utilization, and enhanced cache performance provided by the compressed representation approach. The output generation maintains compatibility with standard solver output formats while providing access to dense output capabilities and compressed state information when required.

The architectural approach achieves inline integration performance through a unified framework that supports multiple integration methods and mathematical model types. The compiler-generated functions provide mathematical optimizations while the general solver supplies the integration algorithm infrastructure, creating a collaborative computational environment that combines the advantages of both specialized optimization and general solver capabilities. This architectural separation enables independent development and optimization of both the symbolic optimization techniques and the integration algorithm implementations while maintaining seamless integration between the two components.

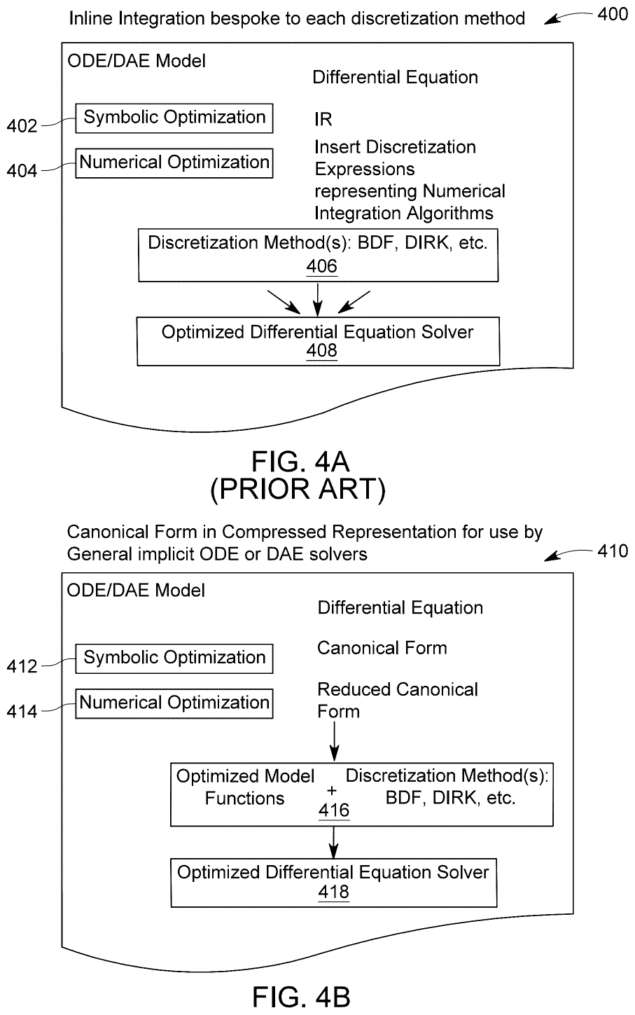

FIGS. 4A and 4B provide a comparative illustration that demonstrates the architectural differences between conventional inline integration approaches and the canonical form methodology described herein. These diagrams highlight the structural limitations in existing methods while showcasing the unified approach enabled by the compressed representation framework for differential equation solving systems.

FIG. 4A depicts the conventional method 400 for solving differential algebraic equation systems using traditional inline integration approaches that require bespoke implementations for each discretization method. This architectural representation illustrates the fragmented nature of existing computational frameworks and the resulting inefficiencies that limit scalability and maintainability in scientific computing applications.

The conventional process begins with symbolic optimizations 402 that generate one or more intermediate representations of the input differential equations. These symbolic optimizations apply mathematical manipulation techniques to simplify equation structures and identify computational efficiencies within the mathematical model. However, the optimizations operate within the constraints imposed by the subsequent discretization-specific implementation requirements, limiting the scope and effectiveness of the symbolic analysis procedures.

Following the symbolic optimization phase, numerical optimizations 404 insert discretization expressions that represent various numerical integration algorithms into the mathematical model. These discretization expressions correspond to specific integration methods such as backward differentiation formulas, diagonally implicit Runge-Kutta methods, and other implicit solving approaches. The insertion process modifies the mathematical structure to incorporate the discretization formulas directly into the equation system, creating a merged mathematical-numerical representation.

The conventional approach requires that each individual discretization method 406 be supported through a separate, customized implementation within the differential equation solver framework. Methods such as backward differentiation formulas, diagonally implicit Runge-Kutta approaches, and other integration techniques each require distinct computational pathways and specialized algorithmic implementations. This requirement creates substantial duplication of effort and computational infrastructure, as each method requires its own optimization procedures, memory management strategies, and computational interfaces.

The conventional differential equation solver 408 operates as a collection of method-specific implementations rather than a unified computational framework. Each discretization method requires specialized code paths, distinct data structures, and customized algorithmic procedures that cannot be shared across different integration approaches. This fragmentation results in increased memory requirements, expanded code base complexity, and substantial maintenance overhead as each method implementation requires independent development and optimization efforts.

The architectural limitations of the conventional approach create inefficiencies in computer systems designed for scientific simulation. The requirement for separate implementations prevents the leveraging of existing general solver infrastructures and results in duplicated code bases that increase memory requirements and computational overhead. Each discretization method maintains its own integration interface and optimization routines, compounding inefficiencies for large-scale scientific computing applications that process systems with thousands or millions of equations.

FIG. 4B illustrates the novel method 410 for solving differential algebraic equation systems through the transformation of equations into canonical forms using compressed representation techniques. This architectural approach demonstrates how the unified canonical form framework eliminates the fragmentation present in conventional methods while enabling superior computational efficiency and broader method compatibility.

The enhanced symbolic optimization 412 phase operates within the canonical form framework to represent differential equations in the standardized mathematical form G(x; v₁, v₂, γ, c)=v₁+M x−γ(h) f(x+v₂, tₙ+ch). This canonical representation provides a universal mathematical interface that enables multiple discretization methods to operate through a shared computational infrastructure. The symbolic optimization process identifies mathematical relationships and dependencies that enable variable elimination and computational complexity reduction while maintaining compatibility with diverse integration approaches.

The numerical optimization 414 phase transforms the canonical form representation into a reduced canonical form that incorporates compressed representation techniques. This optimization process applies symbolic analysis to eliminate algebraically dependent variables and reduce the computational state space from n variables to m variables, where m is substantially less than n. The numerical optimization generates the mapping functions N(x)=y and N⁻¹(y, γ, v₁, v₂) that provide the interface between the complete system representation and the compressed computational state.

The architectural approach disclosed herein combines discretization methods and optimized model functions at step 416 rather than requiring separate implementations for each integration method. This combination process uses the canonical form interface to enable multiple discretization methods to operate through the same optimized computational functions. The discretization methods provide the integration algorithm specifications while the optimized model functions supply the mathematical transformations and computational optimizations derived through symbolic analysis.

The optimized differential equation solver 418 operates as a unified computational framework that supports multiple integration methods through the standardized canonical form interface. Rather than maintaining separate code paths for each discretization method, the solver uses the generated mapping functions and canonical form representations to provide consistent computational interfaces across different integration approaches. This unified approach eliminates the duplication present in conventional methods and provides capabilities previously unavailable in inline integration implementations.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the embodiments described. The terminology used herein was chosen to explain the principles of the embodiments, the practical application or technical improvement over technologies found in the marketplace, or to enable others of ordinary skill in the art to understand the embodiments disclosed herein.

Aspects of the subject matter described herein may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Aspects of the subject matter described herein may take the form of a computer program product embodied in a non-transitory computer readable medium having computer executable program code embodied thereon. A computer readable storage medium may be a tangible medium that can contain, or store a program for use by or in connection with an instruction execution system, apparatus, or device. A computer readable medium may include, but not limited to, an electronic, magnetic, optical, electromagnetic, infrared, or semiconductor system, apparatus, or device, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or a suitable combination thereof.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The flowchart and block diagrams in the figures may illustrate and/or represent the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

What is claimed is:

1. A system for solving nonlinear problems in implicit differential equations, the system comprising:
one or more hardware processors operable to:
represent a set of one or more differential equations in a reduced canonical form:
$$G ( x ; {v}_{1} , {v}_{2} , γ , c ) = {v}_{1} + M x - γ ( h ) f ( x + {v}_{2} , {t}_{n} + ch ) ;$$
generate model-specific functions to the reduced canonical form, comprising:
a first mapping function N(x)=y that determines a nonlinear solver state y from a differential algebraic equation state x; and
a second mapping function N⁻¹(y, γ, v₁, v₂)=x that determines the differential algebraic equation state x from the nonlinear solver state y using integrator parameters,
wherein functions v₁, v₂, and γ(ρh) are integrator-specific functions of a previous integrator state; and
determine a solution to the reduced canonical form by:
determining the nonlinear solver state y for the differential algebraic equation state x; and
determining a step value for a nonlinear state vector using the solution to the reduced canonical form.

2. The system of claim 1, wherein the one or more hardware processors are further operable to generate one or more of:
a model-specific work function W(k),
a model-specific error function E(k), and
a model-specific step controller function newh(k).

3. The system of claim 1, wherein the reduced canonical form is generated using strongly connected components comprising a list of nonlinear solves.

4. The system of claim 3, wherein the nonlinear solves comprise a directed acyclic graph that enables parallelization between independent nonlinear solves.

5. The system of claim 1, wherein at least one of the integrator parameters γ functions as a function of step size h.

6. The system of claim 1, wherein at least one of the integrator parameters γ functions as a constant.

7. The system of claim 1, wherein at least one of the integrator-specific functions v₁ and v₂ is encoded as zero values.

8. The system of claim 1, wherein the system is specialized for ordinary differential equations without mass matrices.

9. The system of claim 1, wherein the system is specialized for fully implicit differential algebraic equations by configuring the mass matrix M using input corresponding to ∂f/∂u′.

10. The system of claim 1, further comprising decompressing a compressed dense output state on demand.

11. The system of claim 1, wherein determining the solution comprises using a decompressed dense output state.

12. The system of claim 1, wherein determining the solution comprises using Hermite interpolation modifications to dense output.

13. The system of claim 1, wherein determining the solution comprises using implicit Runge-Kutta methods including one or more of:
diagonally implicit Runge-Kutta methods,
singly diagonally implicit Runge-Kutta methods, and
Gauss-Radau numerical methods.

14. The system of claim 1, wherein determining the solution comprises using explicit singly diagonal implicit Runge-Kutta methods.

15. The system of claim 1, wherein determining the solution comprises using implicit linear multistep numerical methods including one or more of:
Adams-Moulton methods; and
backward differentiation formula methods.

16. The system of claim 1, wherein determining the solution comprises using semi-implicit methods including Rosenbrock methods.

17. The system of claim 1, wherein determining the solution comprises using fully implicit Runge-Kutta methods for tableaus with fixed order.

18. The system of claim 1, wherein determining the solution comprises using fully implicit Runge-Kutta methods for tableaus with adaptive order, wherein multiple canonical form functions are generated specialized to different allowed orders.

19. The system of claim 1, wherein the one or more hardware processors implement memory allocation strategies optimizing cache performance through:
separate memory pools for the compressed state vectors and intermediate calculation buffers, and
alignment of data structures to processor cache line boundaries.

20. A method for solving nonlinear problems in implicit differential equations, the method comprising:
representing, by one or more hardware processors, a set of one or more differential equations in a reduced canonical form:
$$G ( x ; {v}_{1} , {v}_{2} , γ , c ) = {v}_{1} + M x - γ ( h ) f ( x + {v}_{2} , {t}_{n} + ch ) ;$$
generating model-specific functions to the reduced canonical form;
determining a nonlinear solver state from a differential algebraic equation state using a first mapping function; and
determining a solution to the reduced canonical form using the nonlinear solver state.
